(19) United States
(12) Patent Application Publication
(10) Pub. No.: US 2018/0372027 A1
(43) Pub. Date: Dec. 27, 2018

(54) PROJECTILE FUEL SYSTEM

(71) Applicant: Kenneth Davis, Ruidoso, NM (US)

(72) Inventor: Kenneth Davis, Ruidoso, NM (US)

(21) Appl. No.: 16/017,479

(22) Filed: Jun. 25, 2018

Related U.S. Application Data
(60) Provisional application No. 62/524,830, filed on Jun. 26, 2017.

(51) Int. Cl. F02K 9/46; F02K 9/52; F02K 9/58; F02K 9/50; F02K 9/60; F02K 9/64; F23R 3/00; F23R 3/28

(52) U.S. Cl. CPC F02K 9/46; F02K 9/52; F02K 9/58; F02K 9/50; F02K 9/605; F05D 2270/306; F23R 3/005; F23R 3/002; F23R 3/28; F05D 2240/35; F05D 2260/232; F02K 9/64

(57) ABSTRACT

A projectile fuel system has with a liquid fuel tank, a liquid oxygen tank, a first turbine, and a second turbine. A combining device merges a first carbon dioxide exhaust with the second supercritical carbon dioxide exhaust to form a first heated supercritical carbon dioxide. A control valve proportions the first portion of heated supercritical carbon dioxide and the second portion of heated supercritical carbon dioxide to each of the first turbine and the second turbine, adjust total flow rate both of the first portion of heated supercritical carbon dioxide and the second portion of heated supercritical carbon dioxide and adjust the total flow of supercritical carbon dioxide from a jacket.

### CROSS REFERENCE TO RELATED APPLICATIONS

The present application claims priority to and the benefit of co-pending U.S. Provisional Patent Application Ser. No. 62/524,830 filed on Jun. 26, 2017, entitled “PROJECTILE” (our reference 3055.001). This reference is hereby incorporated in its entirety.

### FIELD

The present embodiment generally relates to a liquid fuel liquid oxidant projectile.

### BACKGROUND

A need exists for enhancing the safety of the propellant pumping system in projectiles.

The present embodiments meet these needs.

### BRIEF DESCRIPTION OF THE DRAWINGS

The detailed description will be better understood in conjunction with the accompanying drawings as follows:

FIG. 1 depicts a diagram of the components of the projectile fuel system according to one or more embodiments.

FIGS. 2A and 2B depicts nozzles according to one or more embodiments.

FIG. 3 depicts a splitter according to one or more embodiments.

FIG. 4 depicts the controller according to one or more embodiments.

FIGS. 5A and 5B depicts the computer readable media according to one or more embodiments.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

Specific structural and functional details disclosed herein are not to be interpreted as limiting, but merely as a basis of the claims and as a representative basis for teaching persons having ordinary skill in the art to variously employ the present invention.

### SUMMARY OF THE INVENTION

The invention relates to a projectile capable of escaping earth's gravity.

The projectile has a housing.

The housing can include a fuel tank with liquid fuel.

An oxidizer tank with a liquid oxygen can be in the housing.

A first turbine can be in the housing connected to an oxidizer pump.

The oxidizer pump can be configured to pump liquid oxygen from the oxidizer tank.

The first turbine can form a first supercritical carbon dioxide exhaust.

A second turbine can be mounted in the housing.

The second turbine can be connected to a fuel pump.

The fuel pump can be for pumping liquid fuel from the fuel tank.

The second turbine can form a second supercritical carbon dioxide exhaust while receiving a second portion of heated supercritical carbon dioxide.

A combining device can receive the first supercritical carbon dioxide exhaust and mix the first carbon dioxide exhaust with the second supercritical carbon dioxide exhaust forming a heated supercritical carbon dioxide.

An oxidizer heat exchanger in the housing can receive liquid oxygen from the oxidizer pump and the heated supercritical carbon dioxide from the combining device and form a heated oxygen and a second heated supercritical carbon dioxide.

A fuel heat exchanger can receive liquid fuel and the second heated supercritical carbon dioxide and form a heated liquid fuel and a cooled heated supercritical carbon dioxide.

A jacket can be mounted around a thrust chamber forming a cooling chamber.

A thrust chamber can be composed of a combustion chamber which has an exit called a throat. The throat exits into a bell-shaped supersonic nozzle. Tubular channels can be embedded in the walls of the thrust chamber so that fluid flowing through the channels removes heat from the thrust chamber. Sufficient heat is removed to keep the thrust chamber from melting.

A supercritical carbon dioxide tank can be in the housing containing supercritical carbon dioxide and configured to receive cooled heated supercritical carbon dioxide from the fuel heat exchanger.

A supercritical carbon dioxide compressor, mounted in the housing, can pump supercritical carbon dioxide to the cooling chamber.

The supercritical carbon dioxide compressor can be mechanically connected to and driven by the first turbine or by the second turbine or by both the first and second turbines.

The thrust chamber can receives the heated liquid fuel and the heated oxygen to generate a high velocity exhaust to move the projectile.

The supercritical carbon dioxide increases in temperature as the supercritical carbon dioxide removes heat from a wall of the thrust chamber, forming the heated carbon dioxide.

The following terms are used herein:

The term “combining device” can refer to a tubing Y connector.

The term “control valve” can refer to a 3-way ball control valve.

The term “fuel heat exchanger” can refer to a printed circuit heat exchanger.

The term “fuel tank” can refer to a section of the housing which contains pressurized helium above a quantity of liquid fuel.

The term “heated oxygen” can refer to heated liquid oxygen, gaseous oxygen, or combinations of liquid and gaseous oxygen. The term heated oxygen refers to liquid oxygen that has increased in temperature at least 10 degrees and up to 400 degrees Fahrenheit.

The term “housing” can refer to a circular cylinder of thin-walled stainless steel.

The term “high velocity exhaust” can refer to a supersonic flow of exhaust gases.

The term “jacket” can refer to tubular channels embedded within the wall of the thrust chamber.

The term “liquid oxygen” can refer to a quantity of oxygen with a temperature between −361.82 degrees Fahrenheit and −297.33 degrees Fahrenheit.

The term “oxidizer heat exchanger” can refer to a tube and shell heat exchanger.

The term “oxidizer tank” can refer to a stainless steel cylinder with torispherical dome end caps.

The term “supercritical carbon dioxide (sCO₂)” can refer to liquid carbon dioxide, gaseous carbon dioxide, or combinations of liquid and gaseous carbon dioxide.

The term “supercritical carbon dioxide feed pump” can refer to a multi-stage centrifugal compressor.

The term “supercritical carbon dioxide tank” can refer to a stainless steel cylinder with torispherical dome end caps.

The term “turbine” can refer to a multi-stage radial inflow turbine.

The critical point of carbon dioxide is at 87.98 degrees Fahrenheit and 1,071 psi. Above the critical point, the liquid and gaseous phases of carbon dioxide merge to form a homogeneous fluid. The term “supercritical carbon dioxide” refers to this homogeneous fluid, and, to a lesser extent, a binary mixture which is composed of this homogeneous phase in conjunction with a gas phase.

In embodiments, the tubing associated with the invention has a much smaller diameter than the tubing normally associated with the gaseous turbine/turbopumps used in such projectiles. This allows higher pressures to be utilized.

The embodiments provide enhanced fire safety over the gaseous turbine/turbopumps normally used in such projectiles.

In the gaseous turbine/turbopumps used in such projectiles, the fuel and the oxidizer are separated by seals. If one of these seals leaks, it can lead to a mixing of fuel and oxidizer which can result in an explosive failure of the pump system. In the embodiments, the fuel and oxidizer are isolated from each other, and are only proximate to supercritical carbon dioxide. A leak in the seal between the first turbine and the oxidizer pump can result in some supercritical carbon dioxide migrating into the oxidizer. This may affect performance, and does not yield a violent chemical reaction. A leak in the seal between the second turbine and the fuel pump can result in some supercritical carbon dioxide migrating into the fuel. This may affect performance, and also does not yield a violent chemical reaction.

A leak in the seal between the first turbine and the oxidizer pump can result in some oxidizer migrating into the supercritical carbon dioxide. If the leak is not excessive, it may affect performance, and does not yield a violent chemical reaction. A leak in the seal between the second turbine and the fuel pump can result in some fuel migrating into the supercritical carbon dioxide. If the leak is not excessive, it may affect performance, and does not yield a violent chemical reaction.

Since the pressure of the supercritical carbon dioxide is always above the supercritical pressure of 1071 psi, the pressure difference across the seals is less than would be experienced in the current gaseous turbine/turbopumps used in such projectiles. This allows the pressure in the combustion chamber to be increased with less concern about seal failure in the pumping system.

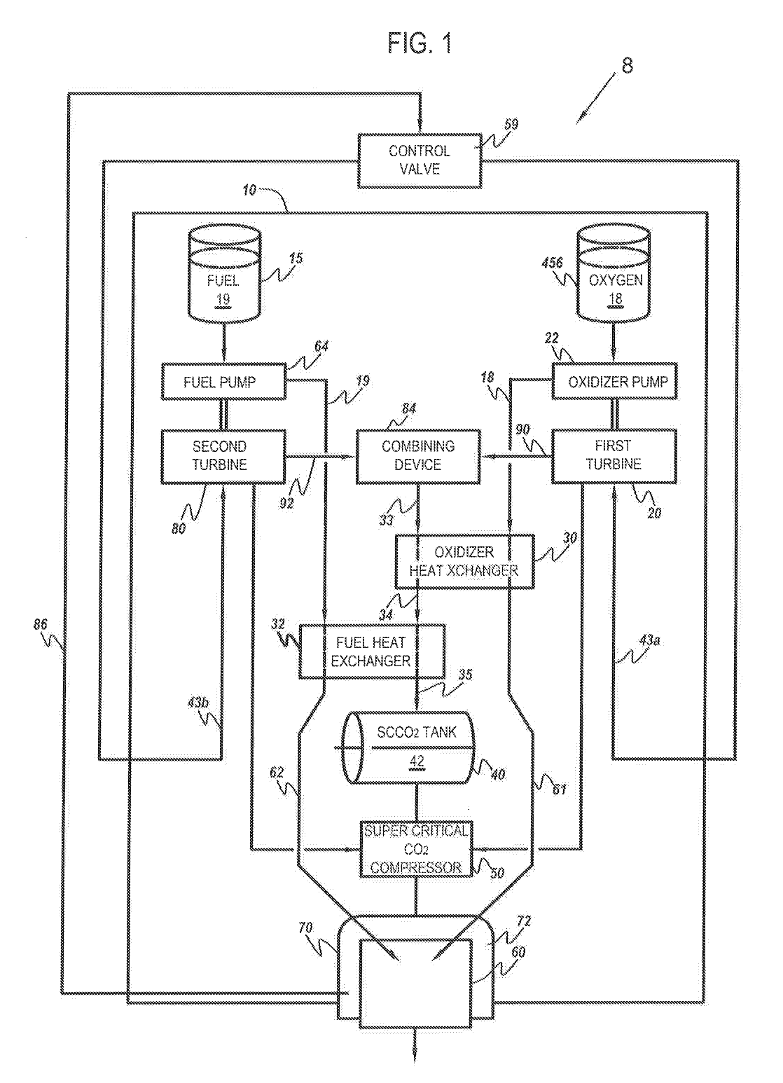

Turning now to the Figures, FIG. 1 shows a projectile 8 having a housing 10.

The housing can be a single walled housing or a double walled housing.

The housing can be a cylinder with a tapered nose or a frustoconical shape.

The housing can be formed from steel or another material that does not deform at high temperatures or over 200 Celsius.

The housing has a fuel tank 15 with liquid fuel 19.

The fuel tank 15 can hold from 1 to 550,000 gallons of liquid fuel.

The liquid fuel typically can be hydrocarbon RP1, liquid hydrogen, or liquified natural gas.

The fuel tank 15 can be made from aluminum alloys, fiberglass composite, or carbon fiber composite.

Insulation can be applied to the fuel tank to keep the fuel in liquid state without excessive vaporization.

The housing has an oxidizer tank 16 with a liquid oxygen 18.

The oxidizer tank 16 can hold from 1 to 200,000 gallons of liquid oxygen

The oxidizer tank 16 can be made from aluminum alloys, fiberglass composite, or carbon fiber composite.

Insulation can be applied to the oxidizer tank 16 to keep the oxygen in liquid state without changing to a gas state.

A first turbine 20 is contained in the housing 10 connected to an oxidizer pump 22 for pumping liquid oxygen 18 from the oxidizer tank 16 and forming a first supercritical carbon dioxide exhaust 90.

The first turbine can be a single or multi-stage centrifugal turbine with a specification of 0.00054 lb/sec/lbf [pounds of sCO₂/second/pound of thrust].

The oxidizer pump 22 can be a centrifugal pump capable of pumping at a rate of 0.00026 gal/sec/lbf [gallons of liquid oxygen/second/pound of thrust].

The first turbine 20 can be configured to receive a first portion of heated supercritical carbon dioxide 43a from a cooling chamber 72 between the jacket 70 and the thrust chamber 60.

The cooling chamber 72 can be composed of tubular channels integral to the wall of the thrust chamber 60. The supercritical carbon dioxide flows through these channels where it is heated from 900 degrees Fahrenheit to 1300 degrees Fahrenheit. The thrust chamber 60 can be made of high nickel alloys (e.g. Inconel).

The housing has a second turbine 80 connected to a fuel pump 64.

The second turbine can be a single or multi-stage centrifugal turbine with a specification of 0.00032 lb/sec/lbf [pounds of sCO₂/second/pound of thrust].

The fuel pump 64 can be a single or multi-stage centrifugal fuel pump able to pump from 0.15 to 511 gal/sec [gallons of fuel/second].

The fuel pump 64 can pump liquid fuel 19 from the fuel tank 15 and the second turbine 80 forming a second supercritical carbon dioxide exhaust 92.

The second turbine 80 can be configured to receive a second portion of heated supercritical carbon dioxide 43b from the cooling chamber 72 within the walls of the thrust chamber 60.

In embodiments, a control valve 59 can proportion the first portion of heated supercritical carbon dioxide 43a and the second portion of heated supercritical carbon dioxide 43b to each of the first turbine 20 and the second turbine 80, adjust total flow rate of both of the first portion of heated supercritical carbon dioxide 43a and the second portion of heated supercritical carbon dioxide 43b and adjust the total flow of supercritical carbon dioxide from the jacket.

The housing has a combining device 84 for merging the first supercritical carbon dioxide exhaust 90 from the first turbine 20 with the second supercritical carbon dioxide exhaust 92 from the second turbine 80 and forming a first heated supercritical carbon dioxide 33.

The combining of the two streams can occur at a flow rate of 0.00086 lb/sec/lbf [pounds of sCO₂/second/pound of thrust].

The heated supercritical carbon dioxide 33 can have a temperature from 700 to 1200 degrees Fahrenheit and flow out of the combining chamber at a flow rate of 0.00086 lb/sec/lbf [pounds of sCO₂/second/pound of thrust].

The combining device 84 can be made from titanium.

The walls of the combining device 84 can be from 0.25 inch to 1.0 inch in thickness.

In embodiments, the combining device 84 can be a Y-connection.

The housing has an oxidizer heal exchanger 30 for receiving liquid oxygen 18 from the oxidizer pump 22 and the heated supercritical carbon dioxide 33 from the combining device 84 to form a heated oxygen 61 and a second heated supercritical carbon dioxide 34.

The oxidizer heat exchanger can be made from beryllium copper and have the specifications to sustain temperatures from 85 to 1200 degrees Fahrenheit without deforming.

The housing has a fuel heat exchanger 32 for receiving liquid fuel 19 from the fuel pump 64 and the second heated supercritical carbon dioxide 34 from oxidizer heat exchanger 30 to form a heated liquid fuel 62 and a cooled heated supercritical carbon dioxide 35.

The fuel heat exchanger can be made from beryllium copper and have the specifications to sustain temperatures from 85 to 1200 degrees Fahrenheit without deforming.

The housing contains a supercritical carbon dioxide tank 40.

The supercritical carbon dioxide tank can hold from 1 to 1000 gallons of supercritical carbon dioxide. The supercritical carbon dioxide can have a temperature from 87.98 degrees Fahrenheit to 150 degrees Fahrenheit.

The supercritical carbon dioxide tank 40 can be configured to receive cooled heated supercritical carbon dioxide 35 from the fuel heat exchanger 32.

A supercritical carbon dioxide compressor 50 is mounted in the housing for pumping supercritical carbon dioxide 42 to the cooling chamber 72.

The supercritical carbon dioxide compressor 50 can be mechanically connected 94b to and driven by the first turbine 20 or 94a by the second turbine 80 or by both the first and second turbines.

The supercritical carbon dioxide compressor can pump supercritical carbon dioxide 42 from the supercritical carbon dioxide tank 40 at a flow rate of 0.00086 lb/sec/lbf [pounds sCO₂/second/pound of thrust].

In this projectile, the thrust chamber 60 can receive the heated liquid fuel 62 and the heated oxygen 61 to generate a high velocity exhaust 94 to move the projectile 8. The supercritical carbon dioxide 42 increases in temperature as the supercritical carbon dioxide 42 removes heat from a wall of the thrust chamber forming the heated supercritical carbon dioxide 43.

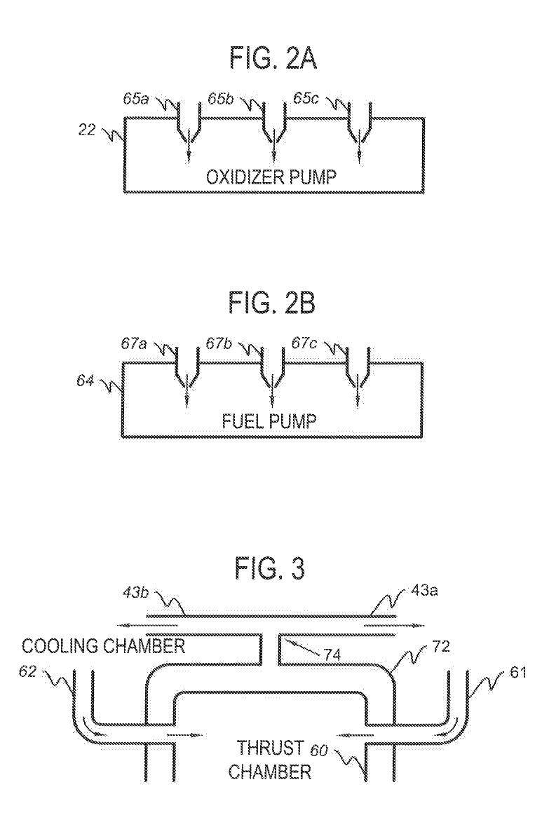

FIG. 2A shows an embodiment having at least one injector 65a-65c in the oxidizer pump 22.

FIG. 2B shows an embodiment having at least one injector 67a-67c in the fuel pump 64.

FIG. 3 shows a jacket flow splitter 74, for splitting the heated supercritical carbon dioxide 43a and 43b.

The jacket flow splitter can be a valve or a plurality of different sizes of tubing.

Heated oxygen is shown flowing into the thrust chamber 60.

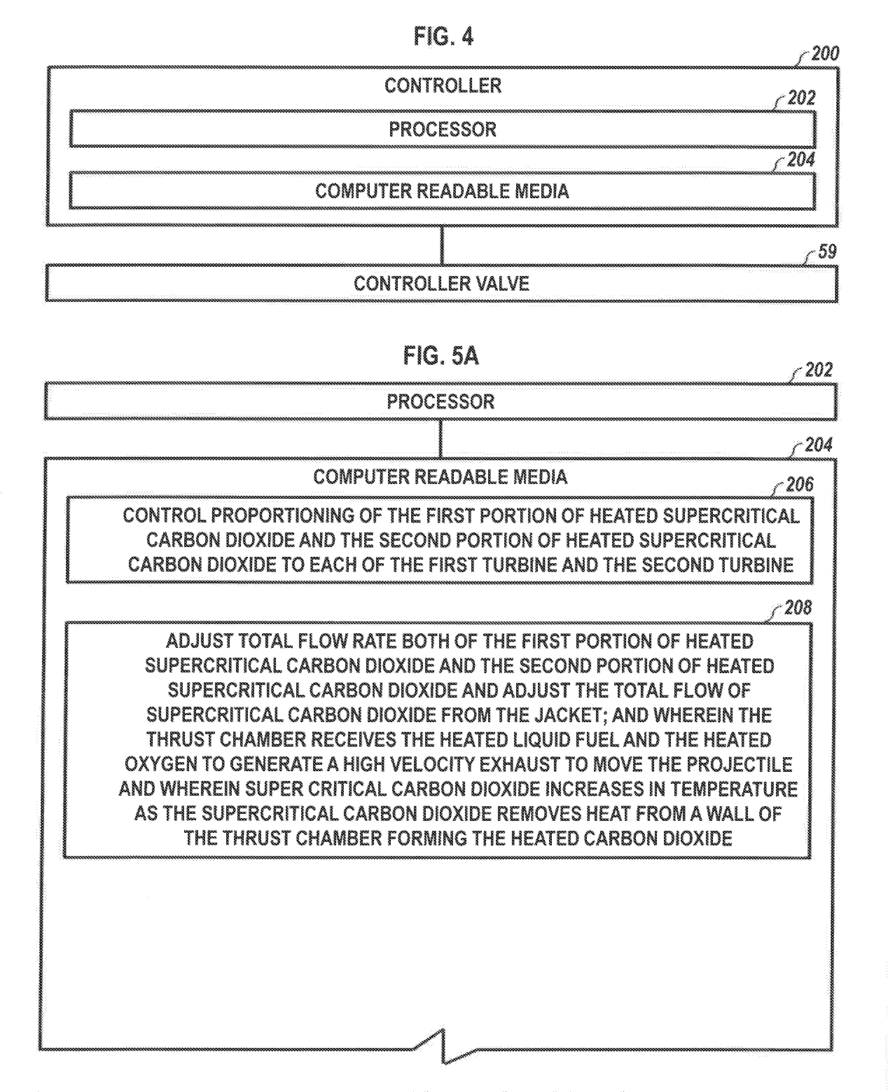

FIG. 4 depicts the controller 200.

The controller can have a processor 202 in communication with computer readable 202 media for controlling the control valve 59. The controller can be powered by an onboard power supply, such as a battery.

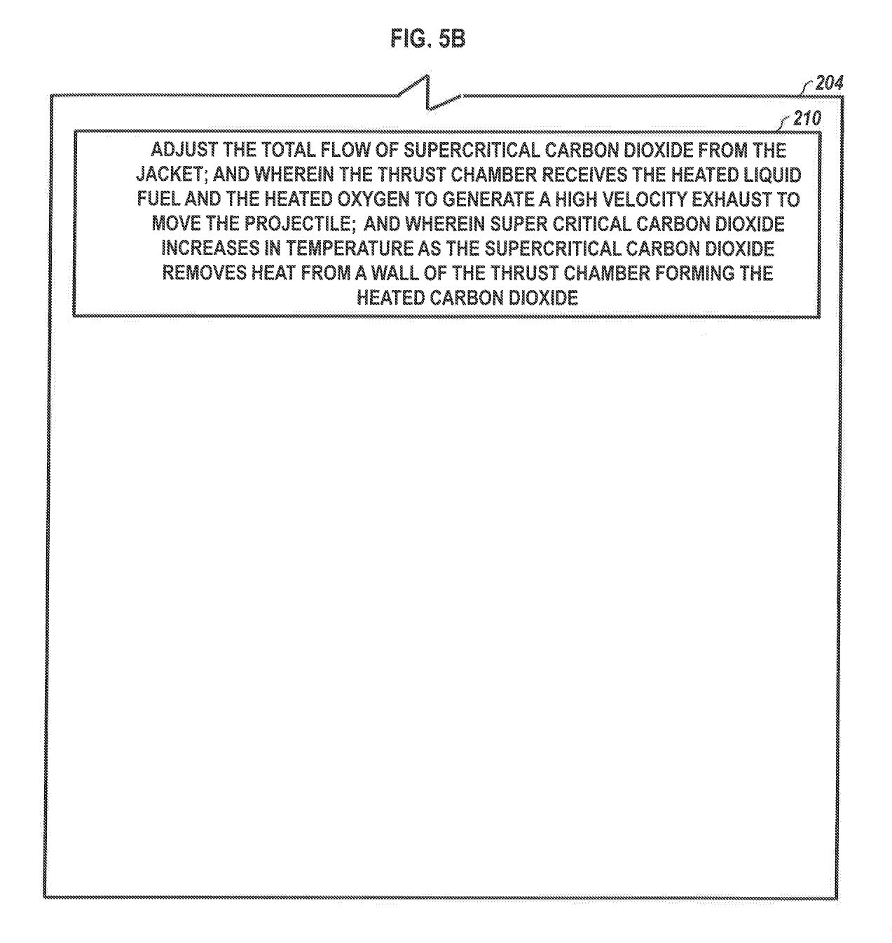

FIGS. 5A and 5B depicts the processor in communication with the computer readable media.

The computer readable media can have computer instructions 206 to instruct the processor to control proportioning of the first portion of heated supercritical carbon dioxide and the second portion of heated supercritical carbon dioxide to each of the first turbine and the second turbine.

The computer readable can include computer instructions 208 to instruct the processor to adjust total flow rate both of the first portion of heated supercritical carbon dioxide and the second portion of heated supercritical carbon dioxide.

The computer readable can include computer instructions 210 to instruct the processor to adjust the total flow of supercritical carbon dioxide from the jacket.

In embodiments, the housing can have a plurality of flutes in the outer surface of the housing for increasing the resistance to buckling.

Each flute in the outer surface of the housing can extend into the body of projectile from 2% to 5% of the housing diameter and be tapered on one end.

In embodiments, the housing can have a rounded nose opposite the thrust chamber.

In embodiments, the housing can have a flat nose opposite the thrust chamber with a plurality of grooves to improve deflection of heat.

In embodiments, each tapered end can graduate from a shallow end proximate a midsection of the housing to a deeper end changing in depth at a rate of change of 0.5 inches of depth per inch forming a fin proximate the thrust chamber.

In embodiments, the cooling chamber is composed of tubular channels integral to the wall of the thrust chamber. The sCO₂ flows through some of these channels. Additional channels can be dedicated to the flow of fuel. This additional flow provides additional cooling of the thrust chamber, and it preheats the fuel.

### Example 1

A projectile 8 has a housing 10. The housing can be made from milled aluminum alloy plate with integral stringers.

A fuel tank 15 with liquid RP1 hydrocarbon fuel 19 is in the housing. The fuel tank can be designed from 2014 T6 aluminum alloy.

An oxidizer tank 16 containing a liquid oxygen 18 is in the housing. The oxidizer tank is designed from insulated milled aluminum alloy.

A first turbine 20 is contained in the housing 10. The first turbine is designed from 309 austenitic stainless steel. The first turbine is connected to an oxidizer pump 22. The oxidizer pump is design from Inconel IN718. The oxidizer pump pumps liquid oxygen 18 at a rate of 24.3 lb/sec [pounds liquid oxygen/second] from the oxidizer tank 16 and forms a first supercritical carbon dioxide exhaust 90. The first turbine is configured to receive a first portion of heated carbon dioxide 43a.

A second turbine 80 in the housing connected to a fuel pump 64. The second turbine is designed from Inconel. The fuel pump pumps liquid fuel 19 from the fuel tank at a rate of 10.2 lb/sec [pounds RP1 fuel/second/pound of thrust] and forms a second supercritical carbon dioxide exhaust 92. The second turbine configured to receive a second portion of heated supercritical carbon dioxide 43b.

A control valve 59, such as a 3-way actuated control ball valve proportions the first portion of heated supercritical carbon dioxide 43a and the second portion of heated supercritical carbon dioxide 43b to each of the first turbine 20 and the second turbine 80, adjust total flow rate both of the first portion of heated supercritical carbon dioxide 43a and the second portion of heated supercritical carbon dioxide 43b and adjust the total flow of supercritical carbon dioxide from the jacket.

A combining device 84, such as a tubing Y connector merges the first carbon dioxide exhaust 90 with the second supercritical carbon dioxide exhaust 92 forming a first heated supercritical carbon dioxide 33.

An oxidizer heat exchanger 30 is contained in the housing. The oxidizer heat exchanger is designed from titanium. The oxidizer heat exchanger receives liquid oxygen 18 from the oxidizer pump 22 and the first heated supercritical carbon dioxide 33 from the combining device 84 and forms a heated oxygen 61 and a second heated supercritical carbon dioxide 34.

A fuel heat exchanger 32 is contained in the housing 10. The fuel heat exchanger is designed from titanium. The fuel heat exchanger receives liquid fuel 19 from the fuel pump 64 and the second heated supercritical carbon dioxide 34 from oxidizer heat exchanger 30 forms a heated liquid fuel 62 and a cooled heated supercritical carbon dioxide 35.

A jacket 70 is mounted around a thrust chamber 60. The jacket and thrust chamber partially extending from the housing, forming a cooling chamber 72 between the jacket and thrust chamber. The jacket is designed from the high-performance alloy Inconel. The thrust chamber is designed from the high-performance alloy such as Inconel.

A supercritical carbon dioxide tank 40 in the housing contains supercritical carbon dioxide 42 and is configured to receive cooled second heated supercritical carbon dioxide 35 from the fuel heat exchanger 32. The supercritical carbon dioxide tank is designed from stainless steel.

A supercritical carbon dioxide compressor 50, such as a multi-stage centrifugal compressor is mounted in the housing for pumping supercritical carbon dioxide 42 at a rate of 8.6 lb/sec [pounds sCO₂/second] to the cooling chamber 72.

A controller 200 has a processor 202 in communication with computer readable media 204. The processor in communication with the control valve, wherein the computer readable media has computer instructions to instruct the processor to control proportioning of the first portion of heated supercritical carbon dioxide and the second portion of heated supercritical carbon dioxide to each of the first turbine and the second turbine, adjust total flow rate both of the first portion of heated supercritical carbon dioxide and the second portion of heated supercritical carbon dioxide and adjust the total flow of supercritical carbon dioxide from the jacket.

The thrust chamber receives the heated liquid fuel and the heated oxygen to generate a high velocity exhaust to move the projectile, and wherein supercritical carbon dioxide 42 increases in temperature as the supercritical carbon dioxide 42 removes heat from a wall of the thrust chamber forming the heated carbon dioxide 43.

### Example 2

A projectile 8 has a housing 10. The housing can be made from aluminum alloy 2014.

A fuel tank 15 with liquid hydrogen 19 is in the housing. The fuel tank can be designed from aluminum alloy 2019.

An oxidizer tank 16 containing a liquid oxygen 18 is in the housing. The oxidizer tank is designed from insulated milled aluminum alloy.

A first turbine 20 is contained in the housing 10. The first turbine is designed from Inconel IN718. The first turbine is connected to an oxidizer pump 22. The oxidizer pump is design from Inconel IN718. The oxidizer pump pumps liquid oxygen 18 at a rate of 22.8 lb/sec [pounds liquid oxygen/second] from the oxidizer tank 16 and forms a first supercritical carbon dioxide exhaust 90. The first turbine is configured to receive a first portion of heated carbon dioxide 43a.

A second turbine 80 in the housing connected to a fuel pump 64. The second turbine is designed from 309 austenitic stainless steel. The fuel pump pumps liquid hydrogen fuel 19 from the fuel tank at a rate of 3.8 lb/sec [pounds liquid hydrogen/second] and forms a second supercritical carbon dioxide exhaust 92. The second turbine configured to receive a second portion of heated supercritical carbon dioxide 43b.

A control valve 59, such as a 3-way actuated control ball valve proportions the first portion of heated supercritical carbon dioxide 43a and the second portion of heated supercritical carbon dioxide 43b to each of the first turbine 20 and the second turbine 80, adjust total flow rate both of the first portion of heated supercritical carbon dioxide 43a and the second portion of heated supercritical carbon dioxide 43b and adjust the total flow of supercritical carbon dioxide from the jacket.

A combining device 84, such as a tubing Y connector the first carbon dioxide exhaust 90 with the second supercritical carbon dioxide exhaust 92 forming a first heated supercritical carbon dioxide 33.

An oxidizer heat exchanger 30 is contained in the housing. The oxidizer heat exchanger is designed from titanium. The oxidizer heat exchanger receives liquid oxygen 18 from the oxidizer pump 22 and the first heated supercritical carbon dioxide 33 from the combining device 84 and forms a heated oxygen 61 and a second heated supercritical carbon dioxide 34.

A fuel heat exchanger 32 is contained in the housing 10. The fuel heat exchanger is designed from A286 stainless steel. The fuel heat exchanger receives liquid hydrogen fuel 19 from the fuel pump 64 and the second heated supercritical carbon dioxide 34 from oxidizer heat exchanger 30 forms a heated liquid fuel 62 and a cooled heated supercritical carbon dioxide 35.

A jacket 70 is mounted around a thrust chamber 60. The jacket and thrust chamber partially extending from the housing, forming a cooling chamber 72 between the jacket and thrust chamber. The jacket is designed from the high-performance alloy Hastelloy. The thrust chamber is designed from the high-performance alloy Hastelloy.

A supercritical carbon dioxide tank 40 in the housing contains supercritical carbon dioxide 42 and is configured to receive cooled second heated supercritical carbon dioxide 35 from the fuel heat exchanger 32. The supercritical carbon dioxide tank is designed from stainless steel.

A supercritical carbon dioxide compressor 50, such as such as a multi-stage centrifugal compressor is mounted in the housing for pumping supercritical carbon dioxide 42 at a rate of 18.6 lb/sec [pounds sCO₂/second] to the cooling chamber 72.

A controller 200 has a processor 202 in communication with computer readable media 204. The processor in communication with the control valve, wherein the computer readable media has computer instructions to instruct the processor to control proportioning of the first portion of heated supercritical carbon dioxide and the second portion of heated supercritical carbon dioxide to each of the first turbine and the second turbine, adjust total flow rate both of the first portion of heated supercritical carbon dioxide and the second portion of heated supercritical carbon dioxide and adjust the total flow of supercritical carbon dioxide from the jacket.

The thrust chamber receives the heated liquid fuel and the heated oxygen to generate a high velocity exhaust to move the projectile, and wherein supercritical carbon dioxide 42 increases in temperature as the supercritical carbon dioxide 42 removes heat from a wall of the thrust chamber forming the heated carbon dioxide 43.

### Example 3

A projectile 8 has a housing 10. The housing can be made from carbon fiber/epoxy composite.

A fuel tank 15 with liquefied natural gas 19 is in the housing. The fuel tank can be designed from carbon fiber/epoxy composite.

An oxidizer tank 16 containing a liquid oxygen 18 is in the housing. The oxidizer tank is designed from insulated 6061 aluminum.

A first turbine 20 is contained in the housing 10. The first turbine is designed from Inconel IN718. The first turbine is connected to an oxidizer pump 22. The oxidizer pump is design from Inconel IN718. The oxidizer pump pumps liquid oxygen 18 at a rate of 24.8 lb/sec [pounds liquid oxygen/second] from the oxidizer tank 16 and forms a first supercritical carbon dioxide exhaust 90. The first turbine is configured to receive a first portion of heated carbon dioxide 43a.

A second turbine 80 in the housing connected to a fuel pump 64. The second turbine is designed from Inconel IN718. The fuel pump pumps liquefied natural gas 19 from the fuel tank at a rate of 8.6 lb/sec [pounds liquefied natural gas/second] and forms a second supercritical carbon dioxide exhaust 92. The second turbine configured to receive a second portion of heated supercritical carbon dioxide 43b.

A control valve 59, such as a 3-way actuated control ball valve proportions the first portion of heated supercritical carbon dioxide 43a and the second portion of heated supercritical carbon dioxide 43b to each of the first turbine 20 and the second turbine 80, adjust total flow rate both of the first portion of heated supercritical carbon dioxide 43a and the second portion of heated supercritical carbon dioxide 43b and adjust the total flow of supercritical carbon dioxide from the jacket.

A combining device 84, such as a tubing Y connector for merging the first carbon dioxide exhaust 90 with the second supercritical carbon dioxide exhaust 92 forming a first heated supercritical carbon dioxide 33.

An oxidizer heat exchanger 30 is contained in the housing. The oxidizer printed circuit heat exchanger is designed from titanium. The oxidizer heat exchanger receives liquid oxygen 18 from the oxidizer pump 22 and the first heated supercritical carbon dioxide 33 from the combining device 84 and forms a heated oxygen 61 and a second heated supercritical carbon dioxide 34.

A fuel heat exchanger 32 is contained in the housing 10. The liquefied natural gas fuel printed circuit heat exchanger is designed from titanium. The fuel heat exchanger receives liquid fuel 19 from the fuel pump 64 and the second heated supercritical carbon dioxide 34 from oxidizer heat exchanger 30 forms a heated liquid fuel 62 and a cooled heated supercritical carbon dioxide 35.

A jacket 70 is mounted around a thrust chamber 60. The jacket and thrust chamber partially extending from the housing, forming a cooling chamber 72 between the jacket and thrust chamber. The jacket is designed from the high-performance alloy Hastelloy. The thrust chamber is designed from the high-performance alloy Hastelloy.

A supercritical carbon dioxide tank 40 in the housing contains supercritical carbon dioxide 42 and is configured to receive cooled second heated supercritical carbon dioxide 35 from the fuel heat exchanger 32. The supercritical carbon dioxide tank is designed from stainless steel.

A supercritical carbon dioxide compressor, such as those designed and manufactured by Barber-Nichols Inc. 50 is mounted in the housing for pumping supercritical carbon dioxide 42 at a rate of 9.5 lb/sec [pounds sCO₂/second] to the cooling chamber 72.

A controller 200 has a processor 202 in communication with computer readable media 204. The processor in communication with the control valve, wherein the computer readable media has computer instructions to instruct the processor to control proportioning of the first portion of heated supercritical carbon dioxide and the second portion of heated supercritical carbon dioxide to each of the first turbine and the second turbine, adjust total flow rate both of the first portion of heated supercritical carbon dioxide and the second portion of heated supercritical carbon dioxide and adjust the total flow of supercritical carbon dioxide from the jacket.

The thrust chamber receives the heated liquid fuel and the heated oxygen to generate a high velocity exhaust to move the projectile, and wherein supercritical carbon dioxide 42 increases in temperature as the supercritical carbon dioxide 42 removes heat from a wall of the thrust chamber forming the heated carbon dioxide 43.

While these embodiments have been described with emphasis on the embodiments, it should be understood that within the scope of the appended claims, the embodiments might be practiced other than as specifically described herein.

What is claimed is:

1. A projectile fuel system, comprising:
a. a housing;
b. a fuel tank with liquid fuel in the housing;
c. an oxidizer tank with a liquid oxygen in the housing;
d. a first turbine in the housing connected to an oxidizer pump, the oxidizer pump for pumping the liquid oxygen from the oxidizer tank and forming a first supercritical carbon dioxide exhaust, the first turbine configured to receive a first portion of heated carbon dioxide;
e. a second turbine in the housing connected to a fuel pump, the fuel pump for pumping liquid fuel from the fuel tank and forming a second supercritical carbon dioxide exhaust, the second turbine configured to receive a second portion of heated supercritical carbon dioxide;
f. a control valve to proportion the first portion of heated supercritical carbon dioxide and the second portion of heated supercritical carbon dioxide to each of the first turbine and the second turbine, adjust a total flow rate both of the first portion of heated supercritical carbon dioxide and the second portion of heated supercritical carbon dioxide and adjust the total flow of the supercritical carbon dioxide from a jacket;
g. a combining device for merging the first carbon dioxide exhaust with the second supercritical carbon dioxide exhaust forming a first heated supercritical carbon dioxide;
h. an oxidizer heat exchanger in the housing for receiving:
(i) the liquid oxygen from the oxidizer pump; and
(ii) the first heated supercritical carbon dioxide from the combining device and forming a heated oxygen and a second heated supercritical carbon dioxide;
i. a fuel heat exchanger in the housing for receiving:
(i) the liquid fuel from the fuel pump; and
(ii) the second heated supercritical carbon dioxide from the oxidizer heat exchanger forming a heated liquid fuel and a cooled heated supercritical carbon dioxide;
j. the jacket mounted around a thrust chamber, the jacket and thrust chamber partially extending from the housing, forming a cooling chamber between the jacket and thrust chamber;
k. a supercritical carbon dioxide tank in the housing containing the supercritical carbon dioxide and configured to receive cooled second heated supercritical carbon dioxide from the fuel heat exchanger;
l. a supercritical carbon dioxide feed pump mounted in the housing for pumping supercritical carbon dioxide to the cooling chamber;
m. a controller comprising a processor in communication with computer readable media, the processor in communication with the control valve, wherein the computer readable media has computer instructions to instruct the processor to control proportioning of the first portion of heated supercritical carbon dioxide and the second portion of heated supercritical carbon dioxide to each of the first turbine and the second turbine, adjust total flow rate both of the first portion of heated supercritical carbon dioxide and the second portion of heated supercritical carbon dioxide and adjust the total flow of supercritical carbon dioxide from the jacket; and wherein the thrust chamber receives the heated liquid fuel and the heated oxygen to generate a high velocity exhaust to move the projectile; and wherein supercritical carbon dioxide increases in temperature as the supercritical carbon dioxide removes heat from a wall of the thrust chamber forming the heated carbon dioxide.

2. The projectile of claim 1, comprising at least one injector in the oxidizer pump.

3. The projectile of claim 1, comprising at least one injector in the fuel pump.

4. The projectile of claim 2, comprising a jacket flow splitter, for splitting the heated carbon dioxide.

5. The projectile of claim 4, wherein the jacket flow splitter is a valve.

6. The projectile of claim 4, wherein the jacket flow splitter comprises a plurality of different sizes of tubing.

7. The projectile of claim 1, comprising a plurality of flutes in the outer surface of the housing for reducing drag on the outer surface of the housing.

8. The projectile of claim 1, wherein the housing comprises a rounded nose opposite the thrust chamber.

9. The projectile of claim 1, the housing comprising a flat nose opposite the thrust chamber with a plurality of grooves to improve deflection of heat.

10. The projectile of claim 7, each flute in the outer surface of the housing extending into the body of projectile from 2% to 12% and tapered on one end.

11. The projectile of claim 10, wherein each tapered end graduates from a shallow end proximate a midsection of the housing to a deeper end changing in depth at a rate of change of 0.5 inches of depth per inch forming a fin proximate the thrust chamber.

12. The projectile of claim 1, comprising: a second jacket surrounding the first jacket, wherein the second jacket forms a second jacket cooling chamber, the second jacket cooling chamber configured to receive a portion of the supercritical carbon dioxide from the supercritical carbon dioxide feed pump and supply a third portion of heated carbon dioxide to the first turbine.

13. The projectile of claim 1, wherein the jacket comprises tubular channels within the walls of the combustion chamber.
